(19) United States
(12) Patent Application Publication
(10) Pub. No.: US 2020/0247540 A1
(43) Pub. Date: Aug. 6, 2020

(54) SELF-DEFENSE WEAPONS POD SYSTEMS AND METHODS FOR AIRCRAFT

(71) Applicant: THE BOEING COMPANY, Chicago, IL (US)

(72) Inventors: Ryan D. Jones, Chesterfield, MO (US); Rayner R. Powell, St. Charles, MO (US)

(73) Assignee: THE BOEING COMPANY, Chicago, IL (US)

(21) Appl. No.: 16/266,163

(22) Filed: Feb. 4, 2019

(51) Int. Cl. B64D 7/08; F41F 3/065; F41H 11/02; B64D 1/06

(52) U.S. Cl. CPC B64D 7/08; B64D 1/06; F41H 11/02; F41F 3/065

(57) ABSTRACT

A self-defense weapons pod system for an aircraft. The self-defense weapons pod system includes a housing containing at least one missile in a non-deployed state, and threat detection sensors coupled to the housing. The threat detection sensors are configured to detect an incoming threat. The missile(s) is configured to be deployed to neutralize the incoming threat.

### FIELD OF THE DISCLOSURE

Embodiments of the present disclosure generally relate to self-defense weapons pod systems and methods for aircraft.

### BACKGROUND OF THE DISCLOSURE

Certain large military aircraft such as tankers, airborne warning and control system (AWACS), transports, and bombers often operate within a weapons engagement zone of adversarial air-to-air and surface-to-air missile systems. In order to defend against such threats, the aircraft activate or deploy countermeasures such as electronic jamming units, chaff, and flares. However, as missile systems advance, typical countermeasures may not be able to eliminate at least some incoming missile threats.

### SUMMARY OF THE DISCLOSURE

A need exists for an effective self-defense system and method for an aircraft. Further, a need exists for a self-defense system for an aircraft that is able to reduce the threat from incoming air-to-air and surface-to-air missiles. Moreover, a need exists for a self-defense system that may be used by an aircraft that may be too large to otherwise evade an incoming missile threat.

With those needs in mind, certain embodiments of the present disclosure provide a self-defense weapons pod system for an aircraft. The self-defense weapons pod system includes a housing containing at least one missile in a non-deployed state, and threat detection sensors coupled to the housing. The threat detection sensors are configured to detect an incoming threat. The missile(s) is configured to be deployed to neutralize the incoming threat. As one non-limiting example, the missiles that may be deployed in response to an incoming threat include, for example, four forwardly-oriented missiles and four rearwardly-oriented missiles.

In at least one embodiment, a threat defense control unit is in communication with the threat detection sensors and the missile(s). For example, the threat defense control unit is contained within the housing. In at least one embodiment, the threat defense control unit is configured to output a threat neutralization signal to the missile(s) in response to receiving one or more incoming threat detection signals from the threat detection sensors. The threat neutralization signal deploys the missile(s). The threat defense control unit may automatically output the threat neutralization signal in response to receiving the threat detection signal(s).

In at least one embodiment, the threat detection sensors include one or more forward threat detection sensors directed forwardly and having a forward field of view that looks forward of the housing, one or more rearward threat detection sensors directed rearwardly and having a rearward field of view that looks rearward of the housing, one or more downward threat detection sensors directed downwardly and having a downward field of view that looks below the housing, one or more port side threat detection sensors directed port and having a port side field of view that looks port of the housing, and one or more starboard side threat detection sensors directed starboard and having a starboard side field of view that looks starboard of the housing. In at least one embodiment, the threat detection sensors may also include one or more upward threat detection sensors directed upwardly and having an upward field of view that looks above the housing.

In at least one embodiment, the self-defense weapons pod system also includes forward closure doors moveably coupled to a fore end of the housing, and/or rearward closure doors moveably coupled to an aft end of the housing.

The self-defense weapons pod system may also include one or more radar sensors in communication with one or both of the threat defense control unit or the missile(s). The radar sensor(s) are configured to guide the missile(s) to the incoming threat.

At least one canister may be retained by the housing. The missile(s) in the non-deployed state may be retained within the canister(s).

Certain embodiments of the present disclosure provide an aircraft including a fuselage, a propulsion system, and at least one self-defense weapons pod system secured to at least one portion of the aircraft. The aircraft may include first and second wings extending from the fuselage. In at least one embodiment, the at least one self-defense weapons pod system includes a first self-defense weapons pod secured to a first underside portion of the first wing and a second self-defense weapons pod system secured to a second underside portion of the second wing.

Certain embodiments of the present disclosure provide a self-defense method for an aircraft. The self-defense method includes containing at least one missile in a non-deployed state in a housing, coupling threat detection sensors to the housing, detecting an incoming threat with the threat detection sensors, and deploying the missile(s) to neutralize the incoming threat. In at least one embodiment, the method also includes receiving, by a threat defense control unit, one or more incoming threat detection signals from the threat detection sensors, outputting, by the threat defense control unit, a threat neutralization signal to the at least one missile in response to the receiving, and deploying the at least one missile in response to the outputting.

Certain embodiments of the present disclosure provide a self-defense weapons pod system for an aircraft. The self-defense weapons pod system includes a housing containing missiles in non-deployed states. The missiles include a first set of forwardly-oriented missiles and a second set of rearwardly-oriented missiles. Forward closure doors are moveably coupled to a fore end of the housing. Rearward closure doors are moveably coupled to an aft end of the housing. One or more forward threat detection sensors are coupled to the housing The forward threat detection sensor(s) are directed forwardly and have a forward field of view that looks forward of the housing. One or more rearward threat detection sensors are coupled to the housing. The rearward threat detection sensor(s) are directed rearwardly and have a rearward field of view that looks rearward of the housing. One or more downward threat detection sensors are directed downwardly and have a downward field of view that looks below the housing. One or more port side threat detection sensors are coupled to the housing. The port side threat detection sensor(s) are directed port and have a port side field of view that looks port of the housing. One or more starboard side threat detection sensors are coupled to the housing. The starboard side threat detection sensor(s) are directed starboard and have a starboard side field of view that looks starboard of the housing. A threat defense control unit is in communication with the threat detection sensors and the missiles. The threat defense control unit is contained within the housing. The forward threat detection sensor(s), the rearward threat detection sensor(s), the downward threat detection sensor(s), the port side threat detection sensor(s), and the starboard side threat detection sensor(s) are configured to detect an incoming threat. The missiles are configured to be deployed to neutralize the incoming threat. The threat defense control unit is configured to output a threat neutralization signal to the missiles in response to receiving one or more incoming threat detection signals from at least one of the threat detection sensors. The threat neutralization signal deploys at least one of the missiles.

### BRIEF DESCRIPTION OF THE DRAWINGS

FIG. 1 illustrates a schematic box diagram of a self-defense weapons pod system of an aircraft, according to an embodiment of the present disclosure.

FIG. 2 illustrates a perspective top view of an aircraft, according to an embodiment of the present disclosure.

FIG. 3 illustrates a perspective top view of the self-defense weapons pod system, according to an embodiment of the present disclosure.

FIG. 4 illustrates a bottom view of the self-defense weapons pod system of FIG. 3.

FIG. 5 illustrates a perspective top view of the self-defense weapons pod system of FIG. 3 having forward closure doors and rearward closure doors in open positions with a self-defense missile deployed.

FIG. 6 illustrates a perspective front view of a fore end of the self-defense weapons pod system of FIG. 3 having the forward closure doors in open positions.

FIG. 7 illustrates a perspective top view of the self-defense weapons pod system mounted to a mounting pylon of an aircraft, according to an embodiment of the present disclosure.

FIG. 8 illustrates a perspective top view of a canister retaining a missile in a non-deployed state, according to an embodiment of the present disclosure.

FIG. 9 illustrates a flow chart of a self-defense method for an aircraft, according to an embodiment of the present disclosure.

### DETAILED DESCRIPTION OF THE DISCLOSURE

The foregoing summary, as well as the following detailed description of certain embodiments will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular condition may include additional elements not having that condition.

Certain embodiments of the present disclosure provide a self-defense weapons pod system for an aircraft that is configured to effectively neutralize incoming missile threats. The self-defense weapons pod system is configured to deploy (for example, launch) one or more missiles at an incoming threat, such as an adversarial air-to-air or surface to-air missile threat. In at least one embodiment, the launched missile(s) are guided to the incoming threat via infrared homing to intercept and destroy or disable the incoming missile threat. The self-defense weapons pod system includes one or more threat detection sensors, such as radio frequency and/or optical sensors, which are configured to detect an incoming missile threat. The self-defense weapons pod system is configured to securely attach to a portion of an aircraft, such as to an underside of a wing or fuselage.

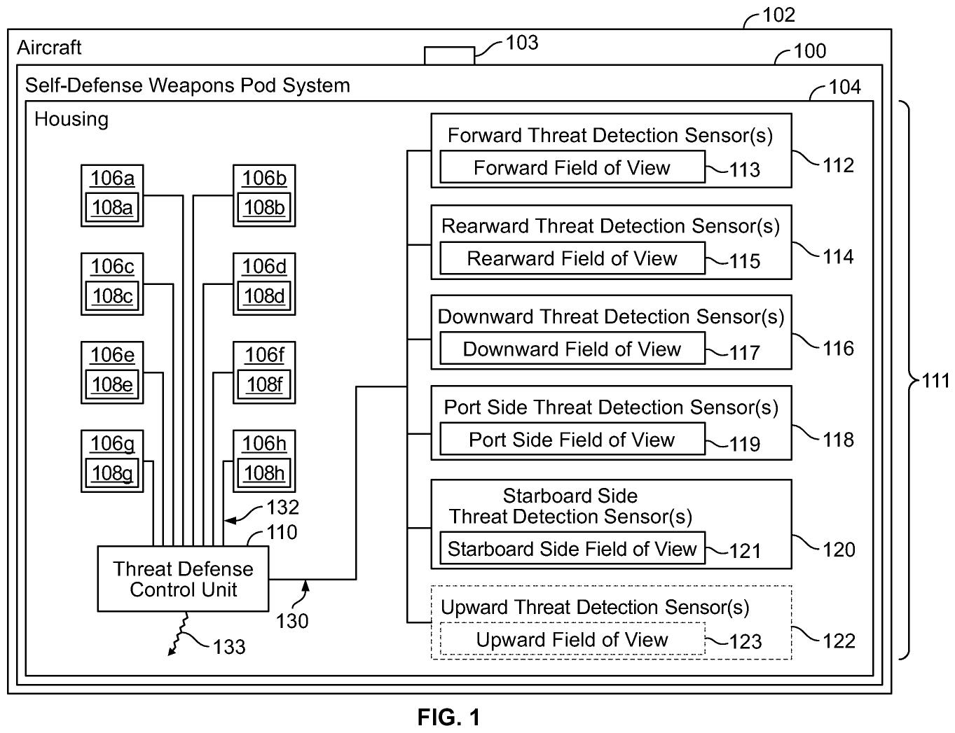

FIG. 1 illustrates a schematic box diagram of a self-defense weapons pod system 100 of an aircraft 102, according to an embodiment of the present disclosure. The self-defense weapons pod system 100 is connected to the aircraft 102 by one or more couplings 103, such as one or more pylons, one or more brackets, and/or the like. The self-defense weapons pod system 100 includes a housing 104 that securely mounts to an exterior portion of the aircraft 102. For example, the housing 104 securely mounts to an underside of a wing of the aircraft. As another example, the housing 104 securely mounts to an outer portion of a fuselage of the aircraft 102.

The housing 104 contains one or more canisters 106 (for example, canisters 106a, 106b, 106c, 106d, 106e, 106f, 106g, and 106h) that each may retain one or more missiles 108 (for example, missiles 108a, 108b, 108c, 108d, 108e, 108f, 108g, and 108h) in non-deployed states (that is, the missiles 108 are retained in the canisters 106 and have not been activated for launch or otherwise launched from the canisters 106). A threat defense control unit 110 is secured on and/or within the housing 104 and is in communication with the missile(s) 108 (such as a launch sub-system of the missile(s) 108) through one or more wired or wireless connections. In at least one embodiment, the housing 104 contains eight canisters 106a-h that retain eight missiles 108a-h in non-deployed states. That is, each of the canisters 106 contains one missile 108 in a non-deployed state. In at least one embodiment, first canisters 106 contain a first set of forwardly-oriented missiles 108, and second canisters 106 contain a second set of rearwardly-oriented missiles 108. For example, four canisters 106 contain four forwardly-oriented missiles 108, and four canisters 106 contain four rearwardly-oriented missiles 108. Optionally, the housing 104 may include more or less than four canisters 106 containing more or less than four missiles 108. For example, in an embodiment, the housing 104 includes two canisters 106, each of which contains a respective missile 108 in a non-deployed state. In at least one other embodiment, the housing 104 includes sixteen canisters 106, each of which includes a respective missile in a non-deployed state. In at least one embodiment, the housing includes one canister 106 containing one missile 108 in a non-deployed state.

The threat defense control unit 110 is also in communication with a plurality of threat detection sensors 111 secured to the housing 104. In at least one embodiment, each of the threat detection sensors 111 is common missile warning system sensor that includes electro-optic missile sensors paired with an electronic control unit. In at least one embodiment, the threat detection sensors 111 include one or more forward threat detection sensors 112, one or more rearward threat detection sensors 114, one or more downward threat detection sensors 116, one or more port side threat detection sensors 118, and one or more starboard side threat detection sensors 120. Optionally, one or more upward threat detection sensors 122 is secured to the housing 104. In at least one embodiment, the threat detection sensors include both the downward threat detection sensor(s) 116 and the upward threat detection sensor(s) 122. In at least one other embodiment, the threat detection sensors include one of the downward threat detection sensor(s) 116 or the upward threat detection sensor(s) 122. The threat defense control unit 110 is in communication with each of the forward threat detection sensor(s) 112, the rearward threat detection sensor(s) 114, the downward threat detection sensor(s) 116, the port side threat detection sensor(s) 118, and the starboard side threat detection sensor(s) 120, such as through one or more wired or wireless connections.

The forward threat detection sensor(s) 112 is directed forwardly and has a forward field of view 113 that looks forward of the housing 104. The forward threat detection sensor(s) 112 is configured to detect incoming threats (for example, incoming air-to-air or surface-to-air missiles) that are in front of the housing 104.

The rearward threat detection sensor(s) 114 is directed rearwardly and has a rearward field of view 115 that looks rearward of the housing 104. The rearward threat detection sensor(s) 114 is configured to detect incoming threats that are behind the housing 104.

The downward threat detection sensor(s) 116 is directed downwardly and has a downward field of view 117 that looks below the housing 104. The downward threat detection sensor(s) 116 is configured to detect incoming threats that are below the housing 104.

The port side threat detection sensor(s) 118 is directed port and has a port side field of view 119 that looks port of the housing 104. The port side threat detection sensor(s) 118 is configured to detect threats that are to a port side of the housing 104.

The starboard side threat detection sensor(s) 120 is directed starboard and has a starboard side field of view 121 that looks starboard of the housing 104. The starboard side threat detection sensor(s) 120 is configured to detect threats that are to a starboard side of the housing 104.

The upward threat detection sensor(s) 122 is directed upwardly and has an upward field of view 123 that looks above the housing 104. The upward threat detection sensor(s) 122 is configured to detect threats that are above the housing 104.

In operation, the threat detection sensors 112, 114, 116, 118, 120, and 122 monitor an airspace around the housing 104 that is within their respective fields of view 113, 115, 117, 119, 121, and 123. In response to detecting an incoming threat, the threat detection sensors 112, 114, 116, 118, 120, and 122 output one or more incoming threat detection signals 130 to the threat defense control unit 110. The threat defense control unit 110 determines the position of the incoming threat via the incoming threat detection signal(s) 130, and outputs a threat neutralization signal 132 to the missile(s) 108, which causes the missile(s) 108 to deploy (for example, eject from the canister(s) 106, activate engines, and home in on the incoming threat, such as via infrared detection and guidance). The threat neutralization signal 132 indicates the position of the incoming threat, as detected by one or more of the threat detection sensors 112, 114, 116, 118, 120, and 122. The missile(s) 108 then intercepts and neutralizes the incoming threat, such as by destroying or disabling the incoming threat.

In at least one embodiment, the threat defense control unit 110 automatically outputs the threat neutralization signal 132, which automatically deploys the missile(s) 108. That is, in at least one embodiment, the threat defense control unit 110 is configured to automatically deploy the missile(s) 108 in response to detection of an incoming threat without pilot or other crew intervention. In at least one other embodiment, before outputting the threat neutralization signal 132, which deploys the missile(s) 108, the threat defense control unit 110 first outputs an alert signal 133 to a pilot or other crew member of the aircraft 102. In response to receiving the alert signal, the pilot or other crew member may then send an authorization signal, such as via one or more controls of the aircraft 102, to the threat defense control unit 110. In response to receiving the authorization signal, the threat defense control unit 110 may then output the threat neutralization signal 132 to the missile(s) 108.

As described herein, the self-defense weapons pod system 100 for the aircraft 102 includes the housing 104 containing at least one missile 108 in a non-deployed state. Threat detection sensors 111 (such as the threat detection sensors 112, 114, 116, 118, 120, and 22) are coupled to the housing 104. For example, the threat detection sensors 111 are securely mounted to portions of the housing 104. The threat detection sensors 111 are configured to detect an incoming threat. The missile(s) 108 is configured to be deployed to neutralize the incoming threat.

As used herein, the term “control unit,” “central processing unit,” “unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the threat defense control unit 110 includes one or more processors that are configured to control operation thereof, as described herein.

The threat defense control unit 110 is configured to execute a set of instructions that are stored in one or more data storage units or elements (such as one or more memories), in order to process data. For example, the threat defense control unit 110 may include or be coupled to one or more memories. The data storage units may also store data or other information as desired or needed. The data storage units may be in the form of an information source or a physical memory element within a processing machine.

The set of instructions may include various commands that instruct the threat defense control unit 110 as a processing machine to perform specific operations such as the methods and processes of the various embodiments of the subject matter described herein. The set of instructions may be in the form of a software program. The software may be in various forms such as system software or application software. Further, the software may be in the form of a collection of separate programs, a program subset within a larger program or a portion of a program. The software may also include modular programming in the form of object-oriented programming. The processing of input data by the processing machine may be in response to user commands, or in response to results of previous processing, or in response to a request made by another processing machine.

The diagrams of embodiments herein may illustrate one or more control or processing units, such as the threat defense control unit 110. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the threat defense control unit 110 may represent processing circuitry such as one or more of a field programmable gate array (FPGA), application specific integrated circuit (ASIC), microprocessor(s), and/or the like. The circuits in various embodiments may be configured to execute one or more algorithms to perform functions described herein. The one or more algorithms may include aspects of embodiments disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

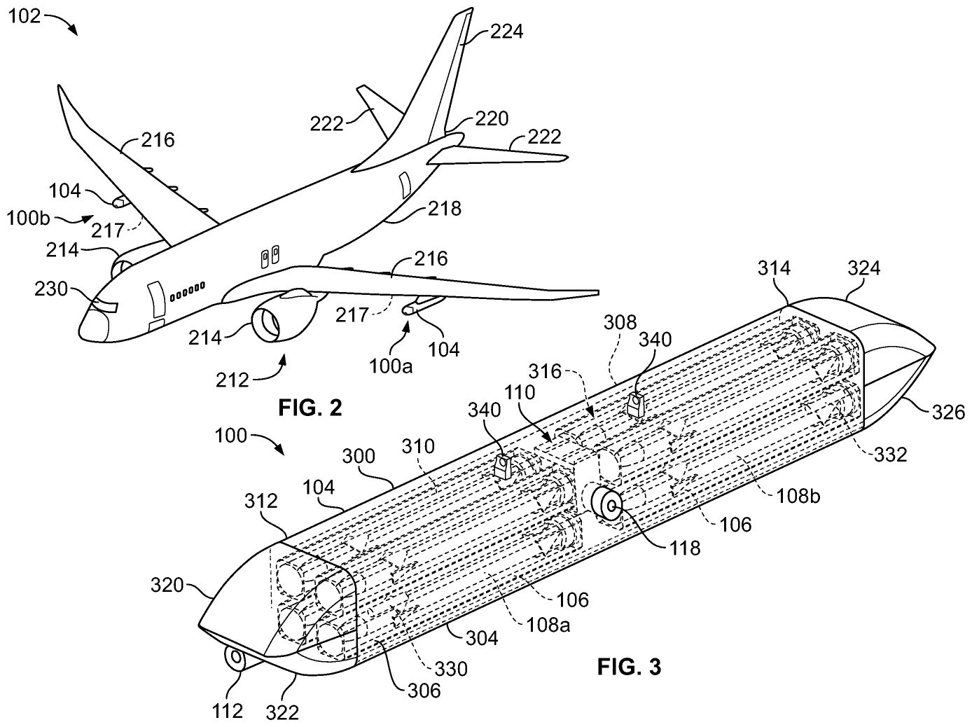

FIG. 2 illustrates a perspective top view of the aircraft 102, according to an embodiment of the present disclosure. The aircraft 102 includes a propulsion system 212 that includes two turbofan engines 214, for example. Optionally, the propulsion system 212 may include more engines 214 than shown. The engines 214 are carried by wings 216 of the aircraft 102. In other embodiments, the engines 214 may be carried by a fuselage 218 and/or an empennage 220. The empennage 220 may also support horizontal stabilizers 222 and a vertical stabilizer 224. The fuselage 218 of the aircraft 102 defines an internal cabin, which includes a cockpit 230.

Self-defense weapons pod systems 100 (such as examples 100a and 100b) are securely mounted to an exterior portion of the aircraft 102. As shown, the housing 104 of the self-defense weapons pod system 100 are securely mounted to undersides 217 of the wings 216. In the illustrated embodiment, two self-defense weapons pod system 100a and 100b are securely mounted to an exterior portion of the aircraft 102. In at least one other embodiment, a single self-defense weapons pod systems 100 may be installed on the aircraft 102. For example, a self-defense weapons pod system 100 may be secured underneath one wing 216. In at least one other embodiment, the self-defense weapons pod system(s) 100 is secured to another portion of the aircraft 102, such as underneath or above a portion of the fuselage 218.

The aircraft 102 may be sized, shaped, and configured other than shown in FIG. 2. For example, the aircraft 102 may be a non-fixed wing aircraft, such as a helicopter. As another example, the aircraft 102 may be an unmanned aerial vehicle (UAV).

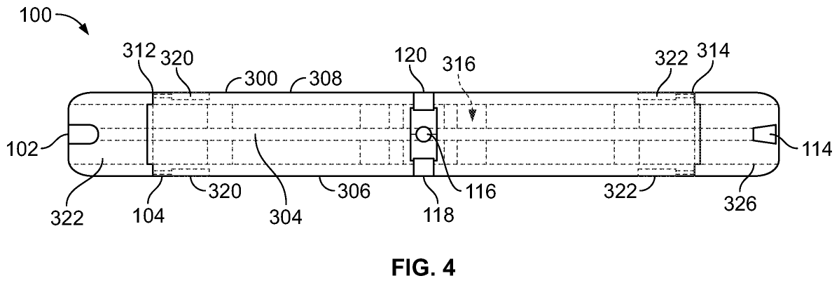

FIG. 3 illustrates a perspective top view of the self-defense weapons pod system 100, according to an embodiment of the present disclosure. FIG. 4 illustrates a bottom view of the self-defense weapons pod system 100 of FIG. 3. Referring to FIGS. 3 and 4, for the purposes of clarity, portions of the self-defense weapons system 100, including the housing 104 and canisters 106, are shown transparent in order to illustrate internal portions.

The housing 104 includes a main body 300 that includes a bottom wall 304 connected to a port side wall 306 and a starboard side wall 308. The port side wall 306 and the starboard side wall 308, in turn, connect to a top wall 310. The bottom wall 304, the port side wall 306, the starboard side wall 308, and the top wall 310 extend between a fore end 312 and an aft end 314, and define an internal chamber 316 therebetween.

As shown, forward closure doors 320 and 322 are moveably coupled to the fore end 312, and rearward closure doors 324 and 326 are moveably coupled to the aft end 314. Alternatively, the housing 104 may not include the forward closure doors 320 and 322 and/or the rearward closure doors 324 and 326.

The canisters 106 containing the missiles 108 in the non-deployed states are contained within the internal chamber 316. As shown, the housing 104 contains four forwardly-oriented missiles 108a within respective canisters 106, and four rearwardly-oriented missiles 108b within respective canisters 106. In at least one other embodiment, the housing 104 includes only forwardly-oriented missiles 108 or rearwardly-oriented missiles 108. In at least one other embodiment, the housing 104 includes less or more than four forwardly-oriented missiles 108 (such as one, two, six, or eight or more) and less or more than four rearwardly-oriented missiles 108 (such as one, two, six, or eight or more).

In at least one embodiment, the threat defense control unit 110 is contained within the internal chamber 316 of the housing 104. As such, the housing 104 provides a protective cover for the threat defense control unit 110.

The forward threat detection sensor 112 is secured to the fore end 312 of the housing 104. For example, the forward threat detection sensor 112 is securely mounted to the forward closure door 322. The self-defense weapons pod system 100 may include additional forward threat detection sensors 112.

The rearward threat detection sensor 114 is secured to the aft end 314 of the housing 104. For example, the rearward threat detection sensor 114 is securely mounted to the rearward closure door 326. The self-defense weapons pod system 100 may include additional rearward threat detection sensors 114.

The downward threat detection sensor 116 is secured to the bottom wall 304. The self-defense weapons pod system 100 may include additional downward threat detection sensors 116.

The port side threat detection sensor 118 is secured to the port side wall 306. The self-defense weapons pod system 100 may include additional port side threat detection sensors 118.

The starboard side threat detection sensor 120 is secured to the starboard side wall 308. The self-defense weapons pod system 100 may include additional starboard side threat detection sensors 120.

In at least one embodiment, the self-defense weapons pod system 100 also includes forward door actuators 330 and rearward door actuators 332. In at least one embodiment, the forward door actuators 330 and the rearward door actuators 332 are linear actuators that are configured to selectively open and close the forward closure doors 320, 322 and the rearward closure doors 324, 326, respectively. The forward door actuators 330 and the rearward door actuators 332 are controlled by the threat defense control unit 110. That is, the threat defense control unit 110 is in communication with the forward door actuators 330 and the rearward door actuators 332 through one or more wired or wireless connections. When the threat defense control unit 110 outputs the threat neutralization signal 132 (as shown and described with respect to FIG. 1), the threat defense control unit 110 operates one or both of the forward door actuators 330 or the rearward door actuators 332 to open the respective forward closure doors 320, 322 or the rearward closure doors 324, 326 in order to allow the missiles 108 to be deployed from the housing 104. Alternatively, in at least one other embodiment, the self-defense weapons pod system 100 does not include the forward closure doors 320, 322, the rearward closure doors 324, 326, the forward door actuators 330, or the rearward door actuators 332.

As shown in FIG. 3, in particular, one or more lugs 340 upwardly extend from the top wall 310. The lugs 340 are configured to secure the self-defense weapons pod system 100 to a portion of the aircraft 102 (shown in FIGS. 1 and 2). For example, the lugs 340 are configured to couple to brackets, ejectors racks, pylons, or the like extending from the portion of the aircraft 102. In at least one other embodiment, the housing 104 of the self-defense weapons pod system 100 is integrally formed with a portion of the aircraft 102.

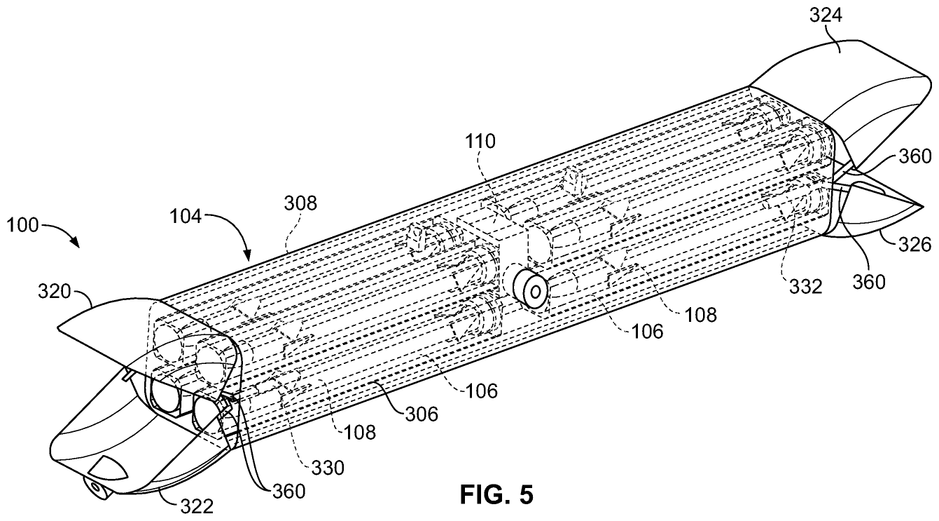

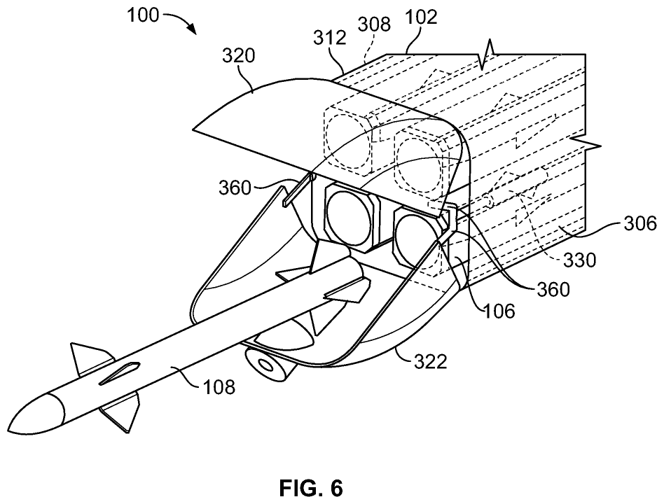

FIG. 5 illustrates a perspective top view of the self-defense weapons pod system 100 of FIG. 3 having forward closure doors and rearward closure doors in open positions. FIG. 6 illustrates a perspective front view of the fore end 312 of the self-defense weapons pod system of FIG. 3 having the forward closure doors in open positions. Referring to FIGS. 5 and 6, the forward door actuators 330 and the rearward door actuators 332 are within the housing 104 proximate to internal surfaces of the port side wall 306 and the starboard side wall 308 outside envelopes of the canisters 106. The forward door actuators 330 and the rearward door actuators 332 are operatively coupled to respective pivot beams 360 that are coupled to the respective forward closure doors 320, 322 and the respective rearward closure doors 324, 326 As the forward door actuators 330 and the rearward door actuators 332 are moved into open positions, as controlled by the threat defense control unit 110, the pivot beams 360 pivot the respective forward closure doors 320, 322 and the rearward closure doors 324, 326 into the open positions shown in FIG. 5.

When the forward closure doors 320, 322 and/or the rearward closure doors 324, 326 are in the open positions, the missile(s) 108 may be deployed from the housing 104. In at least one embodiment, the threat defense control unit 110 launches one missile 108 from the housing 104 at one time. If an incoming threat is not neutralized, the threat defense control unit 110 continues to launch missiles 108 from the housing 104. In at least one other embodiment, in response to detection of an incoming threat, the threat defense control unit 110 launches all of the forward-oriented missiles 108 and/or all of the rearward-oriented missiles 108 to neutralize the incoming threat. In at least one other embodiment, the threat defense control unit 110 ripple launches the forward-oriented missiles 108 and/or the rearward-oriented missiles 108.

In at least one other embodiment, instead of clamshell closure doors, the forward closure doors and the rearward closure doors may be shutter style doors, akin to a shutter of a camera. For example, a single forward closure door and a single rearward closure door shutter open and close. In at least one other embodiment, the closure doors may be configured to roll back and into the housing 104 to allow the missiles 108 to be dispatched therefrom.

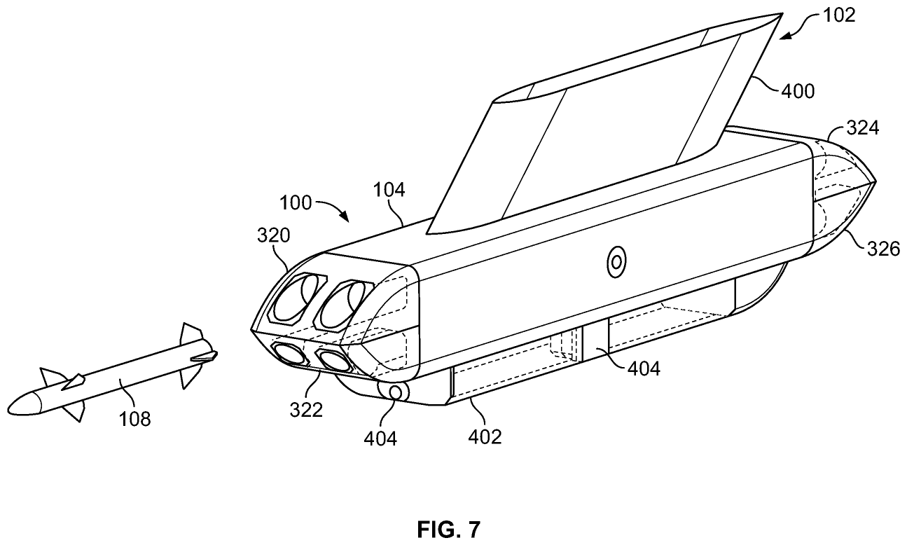

FIG. 7 illustrates a perspective top view of the self-defense weapons pod system 100 mounted to a mounting pylon 400 of the aircraft 102, according to an embodiment of the present disclosure. The mounting pylon 400 extends from a wing 216 of the aircraft 102 (shown in FIG. 2). The mounting pylon 400 securely mounts the self-defense weapons pod system 100 below an underside of the wing 216.

In this embodiment, the forward closure doors 320, 322 and the rearward closure doors 324, 326 are operatively coupled to actuators that are configured to roll open the forward closure doors 320, 322 and the rearward closure doors 326 back and into the housing 104. By rolling the forward closure doors 320, 322 and the rearward closure doors 324, 326 into the housing 104 (instead of pivoting open clamshell doors), aerodynamic drag is reduced when the forward closure doors 320, 322 and the rearward closure doors 324, 326 are opened.

As shown, the self-defense weapons pod system 100 includes a guidance attachment 402 that secures to the housing 104. For example, the guidance attachment 402 secures underneath the housing 104. In at least one other embodiment, the guidance attachment 402 is integrally formed with the housing 104. That is, the guidance attachment 402 may be part of the housing 104.

The guidance attachment 402 retains one or more radar sensors 404, which are in communication with the threat defense control unit 110 and/or the missiles 108. Radar sensors 404 are oriented in a plurality of directions. The radar sensors 404 are configured to guide the missiles 108 to an incoming threat in addition to, or instead of, guidance systems of the missiles 108 (such as infrared guidance systems).

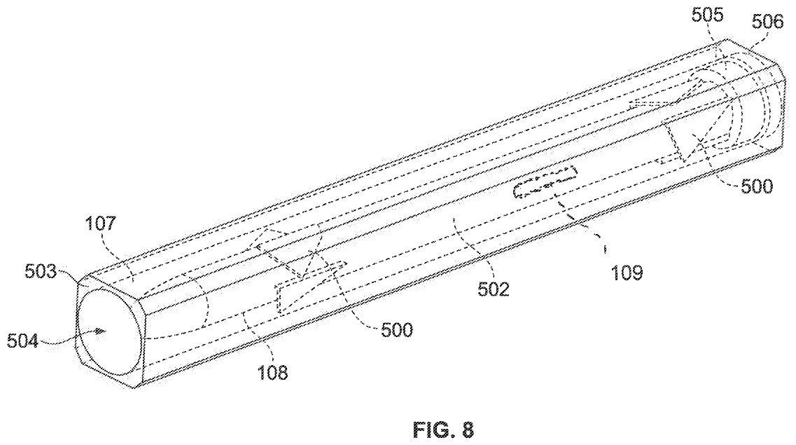

FIG. 8 illustrates a perspective top view of a canister 106 retaining a missile 108 in a non-deployed state, according to an embodiment of the present disclosure. In at least one embodiment, the missile 108 includes a plurality of foldable fins 500 that are folded towards a main body 502 of the missile 108 when the missile 108 is retained within a launch tube 107 within the canister 106. In at least one other embodiment, the fins 500 may be fixed in position, and not configured to fold. An ejection end 503 of the canister 106 includes a frangible cover 504 that is forced open as the missile 108 is ejected from an internal chamber of the canister 106.

A missile ejection gas bag 505 is positioned behind the missile 108. The missile ejection bag 505 is configured to pop open in response to receiving launch command from ejection electronics 506 that are in communication with the threat defense control unit 110. As such, the opening of the missile ejection bag 505 forces the missile 108 out of the launch tube 107 of the canister 106, thereby breaking open the cover 504. As the missile 108 is deployed out of the canister 106, the fins 500 are no longer constrained by the launch tube 107 and outwardly fold. After the missile 108 is out of the canister 106, the engine of the missile 108 is activated to provide thrust, and the missile 108 is guided to an incoming threat via an onboard guidance system (such as infrared sensors), the radar sensors 404 of FIG. 7 that are in communication with a control unit of the missile 108, and/or the like.

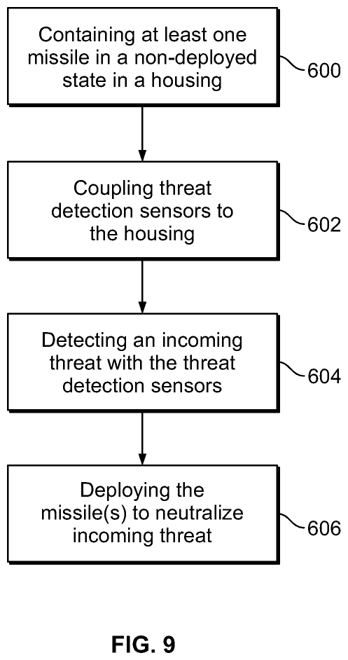

FIG. 9 illustrates a self-defense method for an aircraft, according to an embodiment of the present disclosure. The self-defense method includes containing 600 at least one missile in a non-deployed state in a housing, coupling 602 threat detection sensors to the housing, detecting 604 an incoming threat with the threat detection sensors, and deploying 606 the missile(s) to neutralize the incoming threat. In at least one embodiment, the method also includes receiving, by a threat defense control unit, one or more incoming threat detection signals from the threat detection sensors, outputting, by the threat defense control unit, a threat neutralization signal to the at least one missile in response to the receiving, and deploying the at least one missile in response to the outputting.

As described herein, embodiments of the present disclosure provide effective self-defense systems and methods for aircraft. Further, embodiments of the present disclosure provide self-defense systems and methods for an aircraft that are able to eliminate incoming air-to-air and surface-to-air missile threats. Moreover, embodiments of the present disclosure provide self-defense systems and methods that may be used by an aircraft that may be too large to evade an incoming missile threat.

While various spatial and directional terms, such as top, bottom, lower, mid, lateral, horizontal, vertical, front and the like may be used to describe embodiments of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

1. A self-defense weapons pod system for an aircraft, the self-defense weapons pod system comprising:
a housing containing at least one missile in a non-deployed state, wherein the at least one missile comprises a plurality of fins coupled to a main body, and an engine within the main body; and
threat detection sensors directly secured to the housing, wherein the threat detection sensors are configured to detect an incoming threat, and wherein the at least one missile is configured to be deployed to neutralize the incoming threat.

2. The self-defense weapons pod system of claim 1, further comprising a threat defense control unit in communication with the threat detection sensors and the at least one missile.

3. The self-defense weapons pod system of claim 2, wherein the threat defense control unit is contained within the housing.

4. The self-defense weapons pod system of claim 2, wherein the threat defense control unit is configured to output a threat neutralization signal to the at least one missile in response to receiving one or more incoming threat detection signals from the threat detection sensors, and wherein the threat neutralization signal deploys the at least one missile.

5. The self-defense weapons pod system of claim 4, wherein the threat defense control unit automatically outputs the threat neutralization signal in response to receiving the one or more threat detection signals.

6. The self-defense weapons pod system of claim 1, wherein the at least one missile comprises four forwardly-oriented missiles and four rearwardly-oriented missiles.

7. The self-defense weapons pod system of claim 1, wherein the threat detection sensors comprise:
one or more forward threat detection sensors directed forwardly and having a forward field of view that looks forward of the housing;
one or more rearward threat detection sensors directed rearwardly and having a rearward field of view that looks rearward of the housing;
one or more downward threat detection sensors directed downwardly and having a downward field of view that looks below the housing;
one or more port side threat detection sensors directed port and having a port side field of view that looks port of the housing; and
one or more starboard side threat detection sensors directed starboard and having a starboard side field of view that looks starboard of the housing.

8. The self-defense weapons pod system of claim 1, wherein the threat detection sensors further comprise one or more upward threat detection sensors directed upwardly and having an upward field of view that looks above the housing.

9. The self-defense weapons pod system of claim 1, further comprising one or both of:
forward closure doors moveably coupled to a fore end of the housing; or
rearward closure doors moveably coupled to an aft end of the housing.

10. The self-defense weapons pod system of claim 2, further comprising one or more radar sensors in communication with one or both of the threat defense control unit or the at least one missile, wherein the one or more radar sensors are configured to guide the at least one missile to the incoming threat.

11. The self-defense weapons pod system of claim 1, further comprising at least one canister retained by the housing, wherein the at least one missile in the non-deployed state is retained within the at least one canister.

12. An aircraft comprising:
a fuselage;
a propulsion system; and
at least one self-defense weapons pod system secured to at least one portion of the aircraft, wherein the at least one self-defense weapons pod system comprises:
a housing containing at least one missile in a non-deployed state, wherein the at least one missile comprises a plurality of fins coupled to a main body, and an engine within the main body; and
threat detection sensors directly secured to the housing, wherein the threat detection sensors are configured to detect an incoming threat, and wherein the at least one missile is configured to be deployed to neutralize the incoming threat.

13. The aircraft of claim 12, further comprising first and second wings extending from the fuselage.

14. The aircraft of claim 13, wherein the at least one self-defense weapons pod system comprises a first self-defense weapons pod secured to a first underside portion of the first wing and a second self-defense weapons pod system secured to a second underside portion of the second wing.

15. The aircraft of claim 12, wherein the at least one self-defense weapons pod system further comprises a threat defense control unit in communication with the threat detection sensors and the at least one missile, wherein the threat defense control unit is contained within the housing, wherein the threat defense control unit is configured to output a threat neutralization signal to the at least one missile in response to receiving one or more incoming threat detection signals from the threat detection sensors, and wherein the threat neutralization signal deploys the at least one missile.

16. The aircraft of claim 15, wherein the threat defense control unit automatically outputs the threat neutralization signal in response to receiving the one or more threat detection signals.

17. The aircraft of claim 12, wherein the at least one missile comprises four forwardly-oriented missiles and four rearwardly-oriented missiles.

18. The aircraft of claim 12, wherein the threat detection sensors comprise:
one or more forward threat detection sensors directed forwardly and having a forward field of view that looks forward of the housing;
one or more rearward threat detection sensors directed rearwardly and having a rearward field of view that looks rearward of the housing;
one or more downward threat detection sensors directed downwardly and having a downward field of view that looks below the housing;
one or more port side threat detection sensors directed port and having a port side field of view that looks port of the housing; and
one or more starboard side threat detection sensors directed starboard and having a starboard side field of view that looks starboard of the housing.

19. The aircraft of claim 12, wherein the at least one self-defense weapons pod system further comprises one or more radar sensors that are configured to guide the at least one missile to the incoming threat.

20. A self-defense method for an aircraft, the self-defense method comprising:
containing at least one missile in a non-deployed state in a housing, wherein the at least one missile comprises a plurality of fins coupled to a main body, and an engine within the main body;
directly securing threat detection sensors to the housing;
detecting an incoming threat with the threat detection sensors; and
deploying the at least one missile to neutralize the incoming threat.

21. The self-defense method of claim 20,
receiving, by a threat defense control unit, one or more incoming threat detection signals from the threat detection sensors;
outputting, by the threat defense control unit, a threat neutralization signal to the at least one missile in response to the receiving; and
deploying the at least one missile in response to the outputting.
